(19) United States
(12) Patent Application Publication
(10) Pub. No.: US 2013/0206262 A1
(43) Pub. Date: Aug. 15, 2013

(54) Plumbing Fitting

(71) Applicant: Isotec Limited, (US)

(72) Inventor: Andrew William Southen, Christchurch (NZ)

(73) Assignee: Isotec Limited, Christchurch (NZ)

(21) Appl. No.: 13/846,954

(22) Filed: Mar. 19, 2013

Related U.S. Application Data
(63) Continuation-in-part of application No. 12/162,792, filed on Jul. 31, 2008, now abandoned.

(30) Foreign Application Priority Data
Mar. 14, 2006 (NZ) 545900
Apr. 6, 2006 (NZ) 546421
Aug. 15, 2006 (NZ) 549189

(51) Int. Cl. F17D 1/00

(52) U.S. Cl. CPC F17D 1/00
USPC 137/798

(57) ABSTRACT

A plumbing fitting which includes an inlet pipe connectable to a water supply pipe and an outlet connectable to an appliance, said fitting also including a valve arranged between said inlet pipe and said outlet, said valve being moveable between a first position in which water can flow from said inlet pipe to said outlet, and a second position in which said inlet pipe is shut off from said outlet, characterised in that in a first configuration of the plumbing fitting the outlet does not protrude beyond the profile of the inlet pipe.

### CROSS-REFERENCES TO RELATED APPLICATIONS

This Application is a Continuation-in-Part of pending U.S. patent application Ser. No. 12/162,792, filed on Jul. 31, 2008 and also entitled “Plumbing Fitting”, and hereby claims priority from and the benefit of application Ser. No. 12/162,792, including all priorities claimed by it. The disclosures of application Ser. No. 12/162,792 and its entire file wrapper (included all prior art references cited therewith) are hereby specifically incorporated herein by reference in their entirety as if set forth fully herein.

### FIELD OF THE INVENTION

The present invention relates to a plumbing fitting and in particular to an improved design of blanking-off pipe combining a blanking off pipe with an isolating valve.

### DEFINITION

As used herein, the “profile” of an inlet pipe of a fitting is defined with reference to the plane of the wall through which the inlet pipe protrudes, where wall is the x-y plane and the inlet pipe extends along the z-axis. The “profile” is the sectional elevation viewed from any direction parallel to the x-y plane.

### BACKGROUND OF THE INVENTION

At present, when plumbing is installed in a building, the water supply pipes usually are installed several days, or even several weeks, before the installation of the fittings, (e.g. wash basin, sink, lavatory) to which the pipes are to be connected. This means that the connections to the water supply pipes have to be blanked off until the fittings are installed, and the water supply then has to be connected to the fittings.

The blanking-off system presently in use is shown in FIGS. 1 and 2 of the accompanying drawings, both of which show sections through a building wall and the plumbing fittings used.

In FIG. 1, a standard connector 2 is secured by an integral flange 3 to a building stud or other suitable support 4. The standard connector 2 provides a connector inlet pipe 5 for connection to a water supply pipe 5a, and an outlet pipe 6 which is adapted to engage other fittings. In New Zealand, the standard method is to provide outlet pipe 6 with internal screw threading, but alternatives include external screw threading or adapting outlet pipe 6 to have other fittings brazed on to it. This discussion will refer to a screw threaded outlet pipe 6, but other standard methods are intended to be included. The pipes 5 and 6 are depicted as mutually perpendicular, but may of course be at any selected angle.

When the connector 2 is first secured to the supply pipe 5a, the water supply is turned off at the mains, and before the supply is turned on again at the mains, a blanking off pipe 7 is connected to the outlet pipe 6, to temporarily close off the outlet pipe. The blanking off pipe 7 consists of a pipe which is closed at one end 8 and which is externally screw threaded at the other end 9, for engagement with the screw thread on the outlet pipe 6. The closed end 8 is fitted with a square boss 10 so that the blanking off pipe 7 can be easily gripped with a socket for rotation. The boss 10 and adjacent part of the pipe 7 project through the wall 11 when the construction of the wall is completed.

Blanking off pipe 7 has a linear profile. This allows it to project through only a small hole in wall 11.

Once the appliance which is to be supplied with water via the connector 2 has been installed, the blanking off pipe 7 has to be replaced by an extension pipe 12 and an angle stopcock 13, as shown in FIG. 2. Since water will flow out of the outlet pipe 6 as soon as the blanking off pipe 7 is removed, the water has to be turned off at the mains again before the blanking off pipe 7 is removed and replaced by the extension pipe 12 to which the angle stopcock 13 is fitted. The angle stopcock 13 is of known type, and provides an inlet pipe 14 which is internally screw threaded for connection with the externally screw threaded extension pipe 12, and an outlet pipe 15 which is connected to the pipe work of the appliance (not shown).

Fittings such as a face plate 30 must also be installed while the water is off and before angle stopcock 13 is finally installed. This is because outlet pipe 15 protrudes so that the profile of angle stopcock 13 is such that fittings cannot be slid over it after installation. If the face plate 30 is forgotten, or needs to be changed, the water must be turned off again and angle stopcock 13 removed to install it.

A valve 16 is provided to close off the passage between the inlet pipe 14 and the outlet pipe 15. The valve 16 may be of any suitable type; for example, a conical washer 17 which can be moved into engagement with the edge of a complimentary hole 18; the washer 17 is mounted upon a screw threaded shaft 19 which can be rotated by means of a handle 20 to move the washer in the directions of arrows A.

The above described system works well, but has the drawbacks that it requires the mains water supply to be shut off before the blanking off pipe 7 can be removed, and that three separate components (the blanking off pipe 7, the extension pipe 12 and the angle stopcock 13) are needed to make the connection to the appliance. The shape of these components is such that fittings adjacent the wall, such as face plates, must be installed at a specific time, and cannot be easily added or changed at a later date.

### OBJECTS OF THE INVENTION

An object of the present invention is the provision of a fitting which can be used in the place of the blanking off pipe 7, but which also provides a connection to an appliance without requiring the mains water supply to be shut off. It is a further object of the present invention to provide a fitting which in at least configuration has a substantially linear profile.

### SUMMARY OF INVENTION

The present invention provides a plumbing fitting which includes an inlet pipe connectable to a water supply pipe and an outlet connectable to an appliance, said fitting also including a valve arranged between said inlet pipe and said outlet, said valve being moveable between a first position in which water can flow from said inlet pipe to said outlet, and a second position in which said inlet pipe is shut off from said outlet, characterised in that no part of the fitting extends beyond the profile of the inlet pipe.

In one embodiment, the outlet is in line with the inlet pipe.

In an alternative embodiment the outlet is approximately perpendicular to the inlet pipe and is provided with an outlet pipe, which is removable from the inlet pipe to provide a first configuration in which the outlet does not protrude beyond the profile of the inlet pipe.

The fitting may include at least one section of sidewall adjacent the outlet which is thicker than the average sidewall thickness, so that the outlet pipe engages with the inlet pipe in the thicker section of sidewall.

The body of the fitting may be fabricated from a material selected from the list consisting of: brass, plastics, any other suitable material.

The valve may be any of a range of suitable types, e.g. a conical washer which can be pushed into contact with a complimentary seat, or an o-ring seal which can be pulled into contact with a seating surface. Preferably the valve is moveable by means of a removable tool which engages a socket to drive a valve shaft. Alternatively the valve may be moveable by means of a handle, preferably a dome handle.

### BRIEF DESCRIPTION OF THE DRAWINGS

By way of example only, preferred embodiments of the invention are described in detail with reference to the accompanying drawings, in which:

FIG. 3 shows a section through a first preferred embodiment of the fitting of the present invention secured to a water supply pipe;

FIG. 4 shows an end view of a first preferred embodiment of the fitting of the present invention;

FIG. 5 shows a section through the inlet pipe of a second preferred embodiment of the present invention;

FIG. 6A shows a section through the outlet pipe of a second preferred embodiment of the present invention;

FIG. 6B shows a section through an alternative outlet pipe of a second preferred embodiment of the present invention;

FIG. 7 shows a section through a third preferred embodiment of the fitting of the present invention secured to a water supply pipe;

FIG. 8 shows a section through a fourth preferred embodiment of the fitting of the present invention secured to a water supply pipe;

FIG. 9 shows an exploded sectional view of the fourth preferred embodiment of the fitting of the present invention;

FIG. 10 shows a section through a fifth preferred embodiment of the present invention in a first configuration; and

FIG. 11 shows a section through the fifth preferred embodiment of the present invention in a second configuration.

### FIRST PREFERRED EMBODIMENT

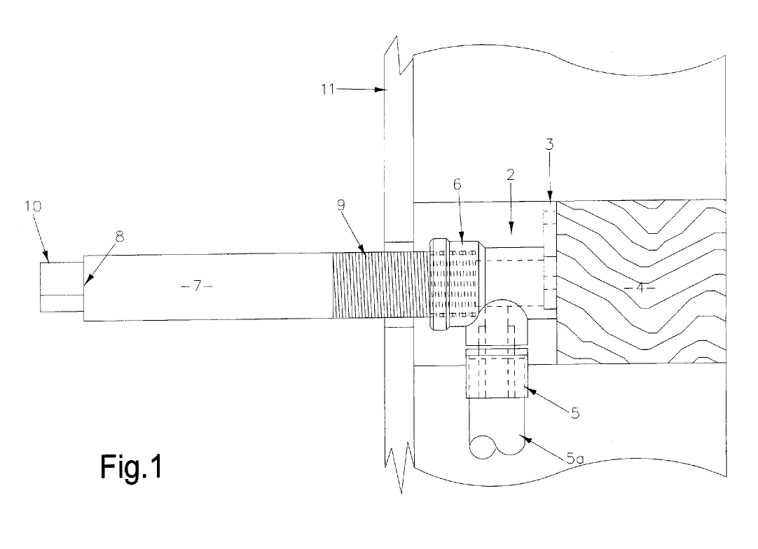

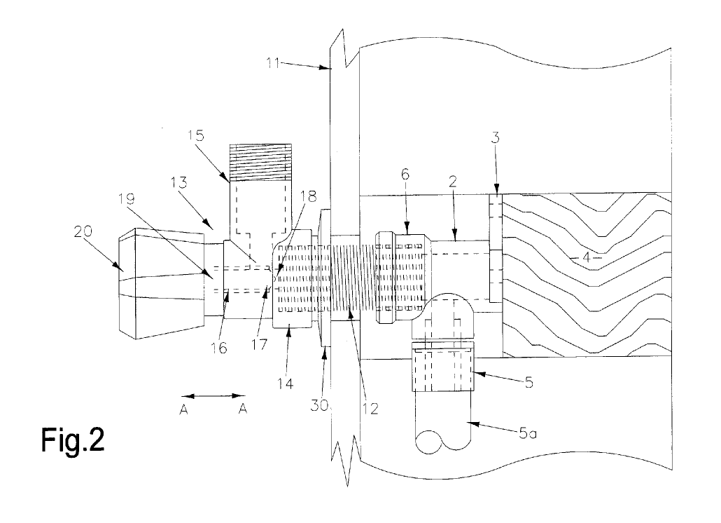

A first preferred embodiment of a fitting according to the present invention is shown in FIGS. 3 and 4.

Referring to FIG. 3, a standard connector 2 as described with reference to FIGS. 1 and 2 is connected to a water supply pipe as described above. To the outlet pipe 6 of the connector 2, in place of the blanking off pipe 7 shown in FIGS. 1 and 2, the fitting 520 of the present invention is secured.

The fitting 520 comprises an externally threaded inlet pipe 521 with an outlet aperture 522a, to which is removably connected an outlet pipe 522, the outer end of which also is externally screw threaded for connection with the inlet pipe of an appliance (not shown).

It will be apparent to one skilled in the art that for all of the described connections between fittings and components, other standard connection adaptations could be used, such as internal or external screw threading, push fit adaptors or brazing.

The inlet pipe 521 and outlet pipe 522 are depicted at right angles to each other, but may in fact be at any selected angle. In this preferred embodiment, the passageway of inlet pipe 521 is offset from its centreline. This provides a thicker side wall 521 a of inlet pipe 521. Outlet pipe 522 is formed as a pipe which is screw threaded into engagement with a correspondingly screw threaded outlet aperture 522a formed in the thicker sidewall 521a. Locating the outlet aperture 522a on this thicker sidewall 521a allows outlet aperture 522a to be deeper than it could be if the passageway were centred, resulting in a much stronger connection between inlet pipe 521 and outlet pipe 522. Fitting 520 may have a reduced diameter end section 581 in order to facilitate handling and allow the installation of a dome handle.

The dimensions and properties of outlet pipe 522 may vary depending on the appliance with which the fitting 520 is to be used. For example, the screw thread on the outer end of outlet pipe 522 may differ to match the connection of different appliances. While fitting 520 is shown with a single outlet pipe 522, it will be appreciated that two or more outlet pipes 522 could be incorporated in the fitting and/or one or more of the outlet pipes 522 may be connected to a T-connection if a connection needed to be made multiple pipes.

Outlet pipe 522 can be removed from outlet aperture 522a, to provide a first configuration in which the fitting 520 has only the end profile of inlet pipe 521. In this first configuration, the outlet consists of outlet aperture 522a, which is recessed into inlet pipe 521. Thus, the outlet does not protrude beyond the profile of the inlet pipe 521 and the profile of the entire fitting in this configuration is the profile of the inlet pipe 521. This allows other fittings such as protective flange 30 to lie flat against the wall 11, and to be slid into place over the inlet pipe 521.

A valve 523 is fitted between the inlet pipe 521 and the outlet 522a. The valve 523 incorporates a valve shaft 524. The valve shaft 524 engages with or is formed integrally with a valve head 572. Valve head 572 is dimensioned so as to engage with a wall 529 which is formed in the interior of the inlet pipe 521 to block an aperture 528 in the wall 529 forming a water-tight seal when the valve 523 is in a closed position.

Valve 523 is moved between a first, open position and a second, closed position by rotating valve shaft 524. Valve shaft 524 includes a screw-threaded section which interacts with a corresponding section of the valve 523 so that the rotation of valve shaft 524 drives valve head 572 in a longitudinal direction.

Valve shaft 524 is fitted with a socket 582 which is adapted to engage a tool. In the embodiment shown in FIG. 4, socket 582 is a hexagonal socket adapted to engage an Allen key, but socket 582 may be adapted to engage a different tool such as a screwdriver. A spring clip 583 is provided to hold the valve 523 in place, preventing valve 523 from being accidentally over-loosened or removed from the fitting 520.

This means of activating valve 523 makes it difficult for the valve to be manipulated without authorisation or by accident. It has the additional benefit that when the tool is removed from the socket 582, no part of valve 523 protrudes beyond the profile of the inlet pipe.

The above described fitting is used as follows:—to fit the connector 2 to the water supply pipe, the mains water supply is shut off in the normal manner. Before the mains water supply is turned on again, the fitting 520 is fitted to the outlet pipe 6 of the connector 2 by engaging the inlet pipe 521 of the fitting 520 with the outlet pipe 6 of the connector 2. The valve 523 of the fitting 520 is then moved to the closed position using a tool engaging socket 582, so that water cannot pass through the aperture 528 in the inlet pipe 521 to reach outlet aperture 522a and outlet pipe 522.

Outlet pipe 522 need not be fitted at this stage, or may be removed, placing the fitting 520 in a first configuration. This ensures that the profile of the fitting 520 no greater than the profile of inlet pipe 521. Wall lining board can be easily fitted around this low profile fitting 520, as it is easy to slide it over the fitting 520 and into place. This also allows fittings such as flange 30 to be slid over fitting 520 and into place at any convenient time. Because the tool is removed from socket 582, it is highly unlikely that the valve 523 will be accidentally opened. Thus, in this first configuration the fitting 520 provides an effective alternative to blanking off pipe 7.

When the time comes to connect the water supply to an appliance, outlet pipe 522 is engaged with the outlet aperture 522a as shown in FIG. 3, and the free end of the outlet pipe 522 is connected to the appliance. Valve 523 can then be opened. If desirable, valve 523 may be fitted with a dome handle (not shown). It is not necessary to shut off the mains water supply, and only a single component, i.e. the fitting 520, is required instead of the three separate fittings required by the prior art.

At any convenient time, valve 523 can be used to isolate the appliance from the mains water supply. Because valve 523 is activated via socket 582, once the tool is removed there is a low risk of the valve 523 being accidentally opened or tampered with. If the wall cladding needs to be repaired or a new flange 30 fitted, valve 523 can be closed, the appliance disconnected and outlet pipe 522 removed to place the fitting in the first configuration, in which the profile of the fitting is the profile of the inlet pipe. This flexibility allows for future work to be undertaken around the fitting 520, without compromising the fitting or its surroundings.

### Second Preferred Embodiment

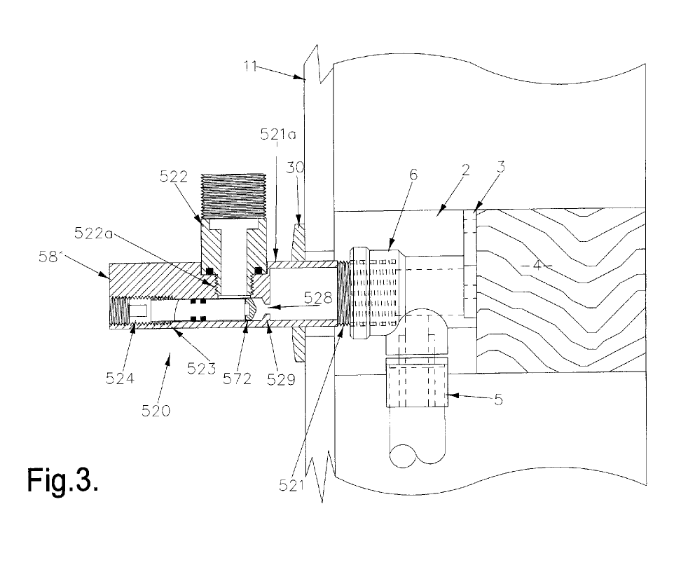

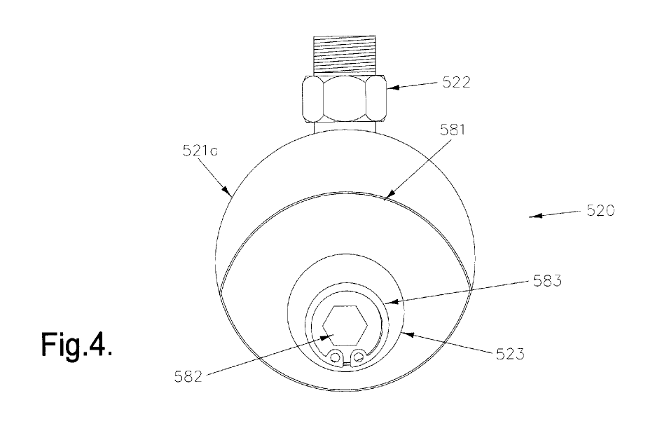

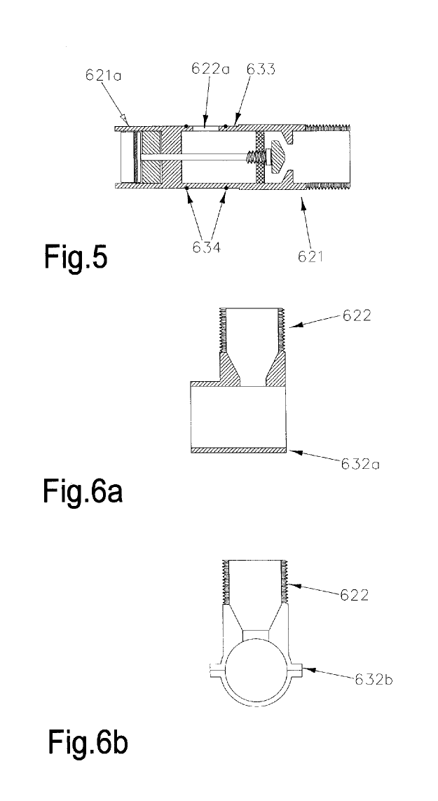

A second preferred embodiment is described with reference to FIGS. 5, 6A and 6B. This embodiment differs from the first preferred embodiment only in the means by which outlet pipe 622 engages with outlet aperture 622a in inlet pipe 621.

In this embodiment inlet pipe 621 includes a narrow section 633 which extends from a first end 621a of the inlet pipe 621 past outlet aperture 622a. Narrow section 633 is fitted with o-rings 634.

An outlet pipe 622 shown in FIG. 6a includes a sleeve section 632a. This sleeve section 632a is adapted to slide fit over narrow section 633 so that outlet pipe 622 is aligned with outlet aperture 622a and o-rings 634 form a water-tight seal between inlet pipe 621 and outlet pipe 622.

An alternative outlet pipe 622 is shown in FIG. 6a. The includes a boss strap 632b, which is adapted to fit around narrow section 633 so that outlet pipe 622 is aligned with outlet aperture 622a and o-rings 634 form a water-tight seal between inlet pipe 621 and outlet pipe 622.

In this embodiment, outlet pipe 622 can be removed to place the fitting in a first configuration. In this first configuration, the outlet consists of outlet aperture 622a, which is recessed into narrow section 633 of inlet pipe 521. Thus, the outlet does not protrude beyond the profile of the inlet pipe 621.

It will be apparent to one skilled in the art that other means of releasably connecting the inlet pipe and outlet pipe in a water-tight manner are available.

### Third Preferred Embodiment

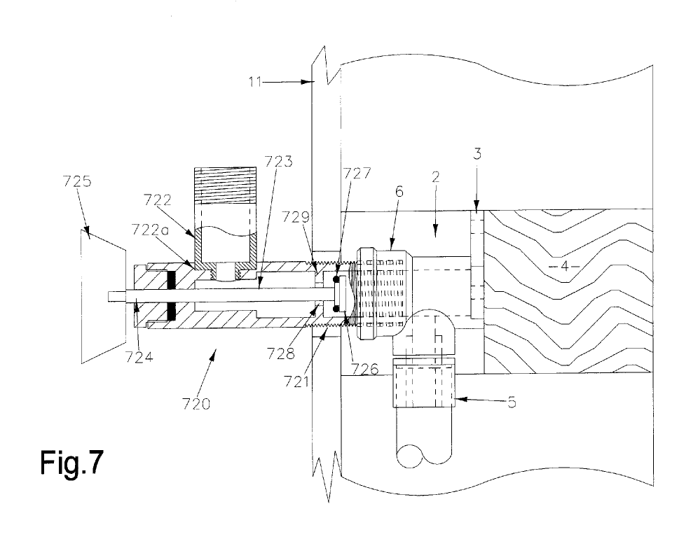

The third preferred embodiment of the present invention, shown in FIG. 7, is substantially similar to the first preferred embodiment. This embodiment differs from the first preferred embodiment in the valve arrangement. The passageway through the inlet pipe 721 of this embodiment is shown as being centred.

A valve 723 is fitted between the inlet pipe 721 and the outlet aperture 722a. The valve 723 incorporates a valve shaft 724 which can be rotated by means of a handle 725 between the open position shown in FIG. 7, in which water can flow from the inlet pipe 721 to the outlet aperture 722a and through outlet pipe 722 to the appliance, and a closed position in which the inlet pipe 721 is closed off from the outlet aperture 722a. Handle 725 and outlet pipe 722 may be removed to provide a first configuration in which no part of the fitting 720 protrudes beyond the profile of inlet pipe 721.

The valve shaft 724 carries a disc 726 at the opposite end to the handle 725; the disc 726 carries an o-ring seal 727. The shaft 724 is arranged to pass through an aperture 728 in a wall 729 which is formed in the interior of the inlet pipe 721. In the closed position of the valve, the valve shaft 724 is rotated until the o-ring seal 727 seats hard against the wall 729, closing off the inlet pipe 721 from the outlet aperture 722.

This valve 723 may be preferred in higher pressure situations, because the water pressure from water supply pipe 5a bears on disc 726, pushing it against wall 729 to improve the seal.

### Fourth Preferred Embodiment

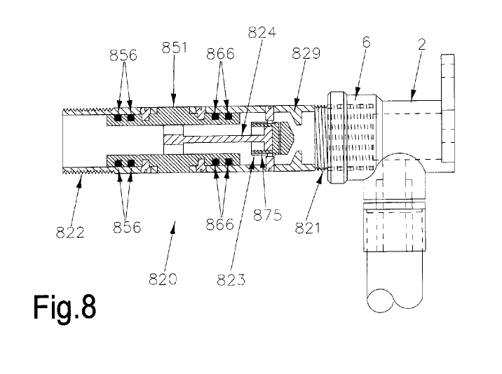

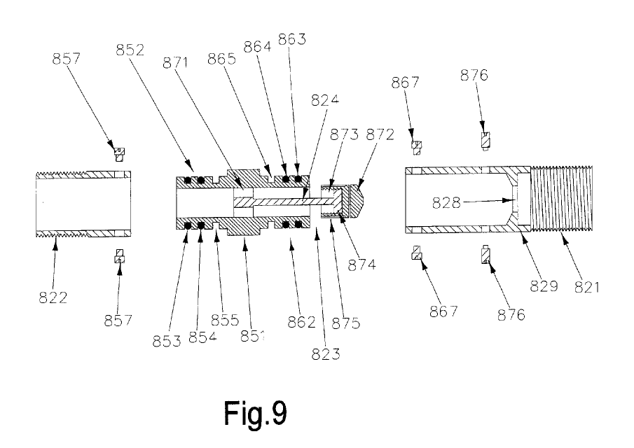

Referring to FIGS. 8 and 9, the fitting 820 comprises an externally threaded inlet pipe 821 which is connected to an outlet pipe 822, the outer end of which also is externally screw threaded for connection with the inlet pipe of an appliance (not shown).

Between inlet pipe 821 and outlet pipe 822 is a valve section 851. Valve section 851 is rotatable relative to inlet pipe 821 and outlet pipe 822, but is sealed so that the three parts are water-tight against each other. This may be achieved by providing valve section 851 with seal sections 852 and 862. At least one of inlet pipe 821, outlet pipe 822 and valve section 851 may incorporate a flat on its outer surface, to allow that component to be easily engaged with a tool such as a spanner, crescent or wrench in order to rotate valve section 851 relative to the inlet pipe 821 and outlet pipe 822.

Seal section 852 is provided with a series of grooves 853, 854, 855, which pass around the circumference of the seal section 852. Grooves 853 and 854 are fitted with o-rings 856. Seal section 852 is dimensioned so that it fits snugly inside outlet pipe 822, with o-rings 856 providing a water-tight seal. Grub screws 857 pass through holes in outlet pipe 822 to engage with the unoccupied groove 855, so that seal section 852 cannot slide out of outlet pipe 822, but can rotate within outlet pipe 822.

In like manner, seal section 862 is provided with a series of grooves 863, 864, 865, which pass around the circumference of the seal section 862. Grooves 863 and 864 are fitted with o-rings 866. Seal section 862 is dimensioned so that it fits snugly inside inlet pipe 821, with o-rings 866 providing a water-tight seal. Grub screws 867 pass through holes in inlet pipe 821 to engage with the unoccupied groove 865, so that seal section 862 cannot slide out of inlet pipe 821, but can rotate within inlet pipe 821.

Valve section 851 is fitted with a valve 823 incorporating a valve shaft 824. Valve shaft 824 is fixed into valve section 851 so that it rotates with valve section 851. The fixing means 871 which hold valve shaft 824 in place in valve section 851 are perforated, so as to allow water to pass straight through valve section 851. The valve shaft 824 engages with a valve head 872. Valve head 872 is dimensioned so as to engage with a wall 829 which is formed in the interior of the inlet pipe 821 to block an aperture 828 in the wall 829 forming a water-tight seal. Valve head 872 is formed with an internally screw-threaded cavity 873 which engages with an externally screw-threaded section 874 of valve shaft 824. Valve head 872 is formed with at least one dorsal slot 875 on its outer surface. Screw 876 passes through the outside of inlet pipe 821 to engage slot 875, so that valve head 872 can only move along inlet pipe 821 and cannot rotate. Thus, the rotation of valve section 851 drives valve 823 between an open position, in which water can flow through aperture 828, and a closed position, in which aperture 828 is blocked by valve head 872.

The above described fitting is used as follows:—to fit the connector 2 to the water supply pipe, the mains water supply is shut off in the normal manner. Before the mains water supply is turned on again, the fitting 820 is fitted to the outlet pipe 6 of the connector 2 by engaging the inlet pipe 821 of the fitting 820 with the outlet pipe 6 of the connector 2. Valve section 851 of the fitting 820 is then rotated to move valve 823 to the closed position, so that water cannot pass from the inlet pipe 821 into valve section 851. An extra cap may be sealed over the end of outlet pipe 822, as additional protection against leakage.

When the time comes to connect the water supply to an appliance, if a protective flange is required around the portion of the fitting 820 that passes through the wall 81, the flange 30 can be slid over the whole of fitting 820. The free end of the outlet pipe 822 is connected to the appliance, and valve section 851 is rotated to open valve 823.

This embodiment has the same advantages of the other embodiments described herein, with the additional benefit of being a unit in which in all configurations the outlet is in line with, and thus does not protrude beyond, the profile of the inlet pipe 821.

### Fifth Preferred Embodiment

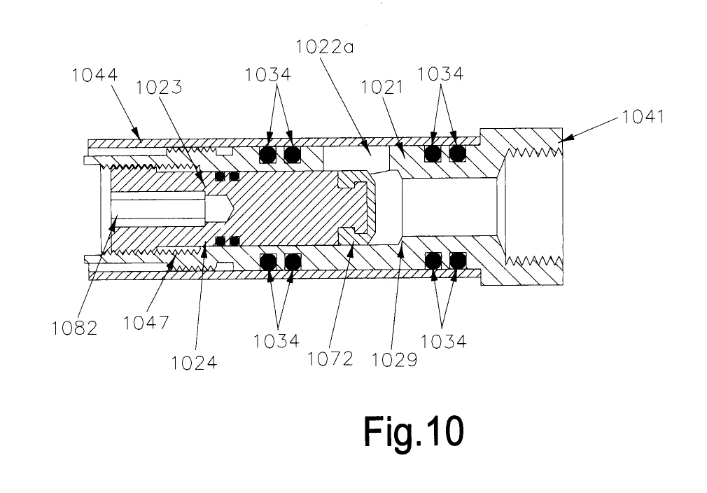

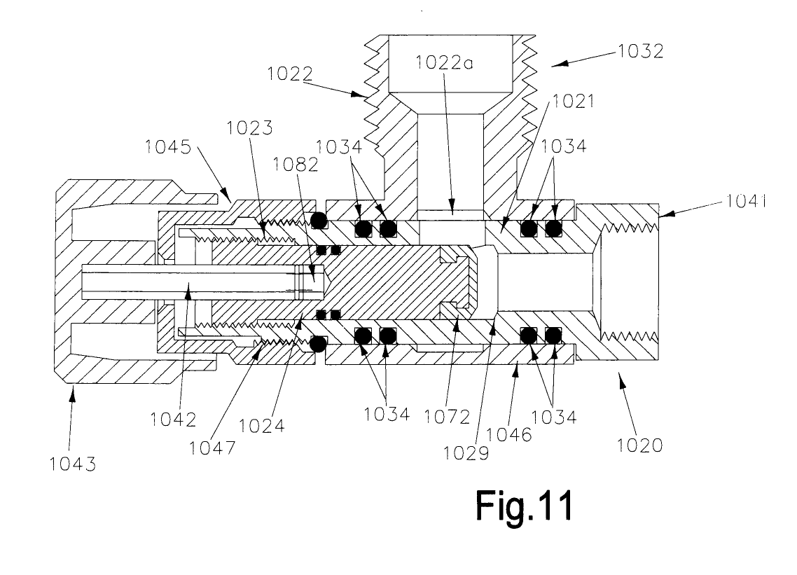

Referring to FIGS. 10 and 11, fitting 1020 includes an inlet pipe 1021 which includes a connector section 1041 adjacent a first end. Connector section 1041 is internally screw threaded, and is connectable to a water supply either directly, or by means of an adaptor, such as a male-male adaptor, or a male-female adaptor to provide a female socket having a different diameter or screw thread for connection to the water supply, or a male-female adaptor for a welded connection to the water supply. The connector section 1041 has a larger diameter than the main body of inlet pipe 1021, and may include external flats for engagement with a wrench or other tool, to assist connection of the inlet pipe 1021 to the water supply.

Inlet pipe 1021 may also include an externally screw threaded cap engagement section 1047 near a second end, which is distal to the first end.

Inlet pipe 1021 includes at least one outlet aperture 1022a along its length. The or each outlet aperture 1022a passes through a sidewall of the inlet pipe 1021 to create a pathway between the interior of the inlet pipe and the outside of the fitting. The exterior of inlet pipe 1021 is fitted with at least one (preferably two) O-rings 1034 on either side of the or each outlet 1022a.

A valve 1023 is enclosed in the inlet pipe 1021, and includes a valve head 1072 connected to a first end of a valve shaft 1024, and a valve seat 1029. Valve shaft 1024 includes a socket 1082, adapted to receive the handle shaft 1042 of a removable handle 1043, so that rotation of the handle 1043 moves the valve head 1072 longitudinally within the inlet pipe 1021, between a first position, in which valve head 1072 is engaged with valve seat 1029 to provide a water-tight seal and a second position, in which water can freely flow between the connector section 1041 and the outlet aperture 1022a.

It is important that the maximum diameter of the inlet pipe 1021 is the diameter of the connector section 1041, so that it can be used in place of a conventional blanking off pipe 7, as described below.

To use the inlet pipe 1021 as a blanking off pipe, the mains water is first switched off (or may not have been connected). Inlet pipe 1021 is connected to the water supply by means of the connector section 1041, and optionally an adaptor as described above. The handle shaft 1042 of removable handle 1043 is engaged with the socket 1082 of valve shaft 1024, and the valve head 1072 moved into the first position, where its engagement with valve seat 1029 creates a water-tight seal within inlet pipe 1021. Removable handle 1043 is then removed from the inlet pipe 1021. To prevent dust etc from entering the inlet pipe 1021 through outlet aperture 1022a or otherwise, a protective sleeve 1044 is used. Protective sleeve 1044 is essentially cylindrical, with one closed off end, and may be fabricated from a plastic material. Protective sleeve 1044 is dimensioned to be a push fit over the main body of inlet pipe 1021. It should be noted that protective sleeve 1044 does not need to form a water-tight seal—this is achieved by valve 1023. The mains water can now be connected, because in this first configuration, inlet pipe 1021 acts as a blanking off pipe.

When it is time to connect the water supply to an appliance, protective sleeve 1044 is removed and discarded. To complete the fitting, outlet sleeve 1032 and locking cap 1045 are used.

Outlet sleeve 1032 includes a substantially cylindrical body section 1046 which is dimensioned to be a close fit around the main body of inlet pipe 1021. Perpendicular to the body section 1046 is an outlet pipe 1022. Outlet sleeve 1032 is configured so that when cylindrical body section 1046 is engaged around inlet pipe 1021, a continuous path is formed from the interior of inlet pipe 1021, through outlet aperture 1022a, into outlet sleeve 1032 and into outlet pipe 1022. The body section 1046 may include one or more internal narrow sections to engage with the o-rings 1034 to create a water-tight seal between outlet sleeve 1032 and inlet pipe 1021.

Locking cap 1045 is internally screw threaded to engage with the cap engagement section 1047 on the exterior of inlet pipe 1021. It is substantially closed off at one end, but includes an aperture (not shown). Locking cap 1045 is screwed on to the second end of inlet pipe 1021 after outlet sleeve 1032 has been slid into place, to hold outlet sleeve 1032 in position.

Removable handle 1043 is then re-attached by passing handle shaft 1042 through the aperture in locking cap 1045 into socket 1082.

The outlet pipe 1022 can now be connected to an appliance by conventional means. Handle 1043 can then be used to move valve head 1072 into the second position, so that water from the water supply is free to flow through inlet pipe 1021, through outlet aperture 1022a, into outlet pipe 1022 and into the appliance.

If at any time it is desired to stop the flow of water to the appliance, the handle 1043 can be used to move the valve head 1072 into the first position, and the flow of water will be cut off by valve 1023.

We claim:

1. A plumbing fitting, comprising: an inlet pipe extending substantially longitudinally along a longitudinal axis and having a cross-section perpendicular to said longitudinal axis, said inlet pipe including:
at a first end, a connector section;
at least one outlet aperture; and
a valve, including: a valve head and a valve seat in the interior of the inlet pipe, actuating means capable of holding the valve head in a first position in which the valve head is engaged with the valve seat to provide a water-tight seal between the connector section and the outlet aperture, said actuating means further being capable of holding the valve head in a second position in which water can freely flow between the connector section and the outlet aperture, and said actuating means further being capable of moving the valve head between said first position and said second position;
wherein a maximum cross-section of the fitting, including said valve and said actuating means, perpendicular to the longitudinal axis of the inlet pipe, is the cross-section of the connector section.

2. A plumbing fitting according to claim 1, wherein the body of the fitting is fabricated from a material selected from a list consisting of: brass or plastics.

3. A plumbing fitting according to claim 1, wherein the valve is moveable by means of a removable tool which engages a socket to drive a valve shaft.

4. A plumbing fitting according to claim 3, wherein the tool is a handle.

5. A plumbing fitting according to claim 4, wherein the handle is a dome handle.

6. A plumbing fitting according to claim 1, wherein the valve head comprises a conical washer.

7. A plumbing fitting according to claim 1, including one or more o-rings encircling the inlet pipe on either side of the outlet aperture.

8. A plumbing fitting for use as a blanking off pipe, comprising the combination of the inlet pipe according to claim 1 with a substantially cylindrical protective sleeve.

9. A plumbing fitting for use in connecting a water supply to an appliance, comprising the combination of the inlet pipe according to claim 1 with an outlet sleeve including a body section adapted to encircle the body of the inlet pipe proximate the outlet aperture, and further including an outlet pipe configured to align with the outlet aperture and connectable at a distal end to an appliance.

10. A plumbing fitting according to claim 9, further including a locking cap adapted to engage with a second end of the inlet pipe to hold the outlet sleeve in place.
